(19) United States
(12) Patent Application Publication
(10) Pub. No.: US 2013/0318868 A1
(43) Pub. Date: Dec. 5, 2013

(54) MAPLE SAP COLLECTION SYSTEM AND METHOD

(71) Applicant: LES PRODUITS VERSAPROFILES, INC., SAINT-LAZARE-DE-BELLECHASSE (CA)

(72) Inventors: ALEXANDRE LEGER, ST-LAMBERT-DE-LAUZON (CA); MARTIN DEMERS, LEVIS (CA)

(73) Assignee: LES PRODUITS VERSAPROFILES, INC., SAINT-LAZARE-DE-BELLECHASSE (CA)

(21) Appl. No.: 13/833,183

(22) Filed: Mar. 15, 2013

Related U.S. Application Data
(60) Provisional application No. 61/652,387, filed on May 29, 2012.

(51) Int. Cl. A01G 23/10

(52) U.S. Cl. CPC A01G 23/10
USPC 47/52; 47/58.1 R

(57) ABSTRACT

A sap collection method and system, the system comprising at least a first line of a first diameter, at least a second line of a second diameter, the second diameter being at most equal to the first diameter; and a connection in fluid communication between the second line and the first line for sap collection from the first line to the second line; wherein the connection comprises a material of walls of an opening in a wall of the first line fused with a material of an end of the second line and for a connecting part engaging an end of the second line.

### CROSS REFERENCE TO RELATED APPLICATIONS

This application claims benefit of U.S. provisional application Ser. No. 61/652,387, filed on May 29, 2012. All documents above are incorporated herein in their entirety by reference.

### FIELD OF THE INVENTION

The present invention relates to a maple sap collection system and method. More specifically, the present invention is concerned with a fused collection system and method.

### BACKGROUND OF THE INVENTION

Typically, a line system is supported amongst trees from which sap is to be collected. The line system includes main lines and a plurality of draining lines, each draining line typically extending from a respective tree to a main line to convey sap from the tree to the main line. The main lines are in fluid communication with each of the respective draining lines through connectors. The main line may also be connected to a wet and dry line connected to a vacuum pump in the sugarhouse.

Typically, connectors are multi-parts fittings fastened around the main line. Recurrent problems are that the connectors may become loose and move about the main line over time, and generally micro leakage occurs.

There is still a need in the art for a connection in a sap collecting system overcoming the shortcomings of the prior art.

### SUMMARY OF THE INVENTION

More specifically, in accordance with the present invention, there is provided a sap collection system, comprising at least a first line of a first diameter, at least a second line of a second diameter, the second diameter being at most equal to the first diameter; and a connection in fluid communication between the second line and the first line for sap collection from the first line to the second line; wherein the connection comprises a material of walls of an opening in a wall of the first line fused with a material of one of: i) an end of the second line and ii) a connecting part engaging an end of the second line.

There is further provided a system for sap collection, comprising a first line with an integral collector; and at least a second line; wherein the integral collector is in fluid communication with the first line and adapted for connection in fluid communication with the second line for sap collection from the first line to the second line.

There is further provided a method for installing a sap collecting system in a bush, comprising providing at least a first line; providing at least a second line; and fusing the material of walls of an opening in a wall of the first line with a material of one of: i) an end of the second line and ii) a connecting part engaging an end of the second line, into a connection in fluid communication between the second line and the first line for sap collection from the first line to the second line.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 shows a connection between a main line and a draining line according to an embodiment of an aspect of the present invention;

FIG. 2 shows a sectional view a connection between a main line and a draining line according to an embodiment of an aspect of the present invention;

FIG. 3 show a) a perspective view; b) a perspective sectional view; and c) a section, of a connector according to an embodiment of an aspect of the present invention:;

FIG. 4 show a) an exploded view showing a first line, a base and a connector; b) an exploded view showing a first line with an integral base and a connector; and c) a first line according to an embodiment of an aspect of the present invention;

FIG. 5 is a) an exploded view showing a first line, a second line and a base; b) an exploded view showing a first line with a base fused thereon and an opening through both the base and the wall of the first line, and a second line; c) a first line connected to a second line according to an embodiment of an aspect of the present invention; d) a first line and a second line prior to connection, and e) a first line connected to a second line according an embodiment of an aspect of the present invention;

FIGS. 6a)-h) show steps of a method according to an embodiment of an aspect of the present invention;

FIG. 7 is a schematic view of a sap collecting system according to an embodiment of an aspect of the present invention;

FIGS. 8 a)-d) show steps of a method according to an embodiment of an aspect of the present invention;

FIG. 9 show a) a first line and a connector, b) a first line with an integrated connector, according to an embodiment of an aspect of the present invention; and

FIG. 10 is a perspective view of connections in a sap collection system according to an embodiment of an aspect of the present invention,

### DESCRIPTION OF EMBODIMENTS OF THE INVENTION

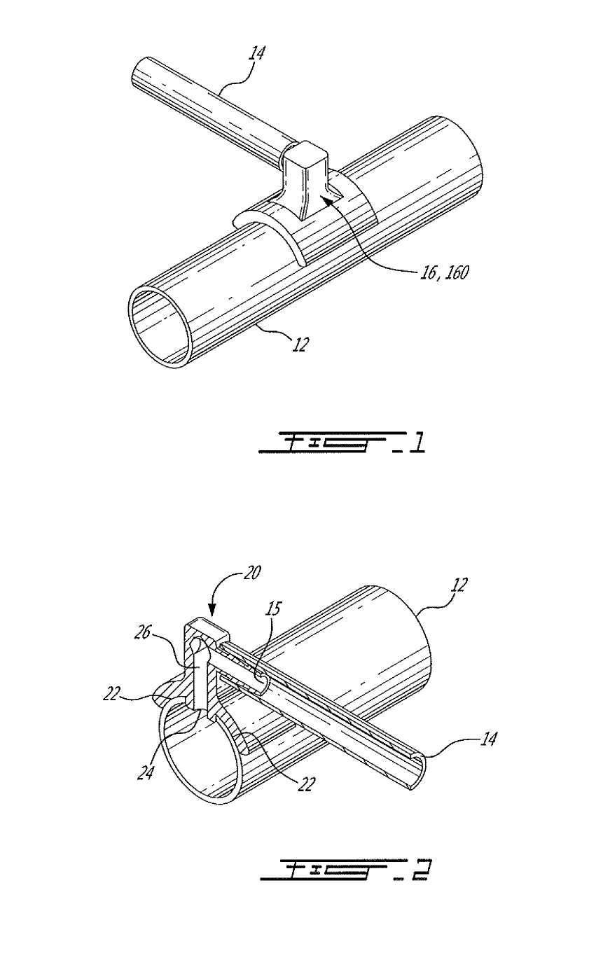

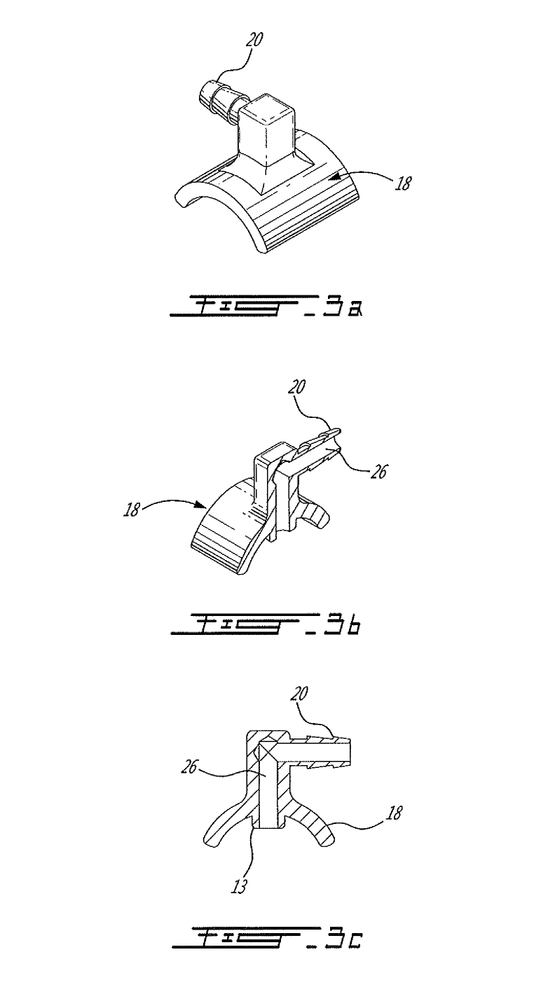

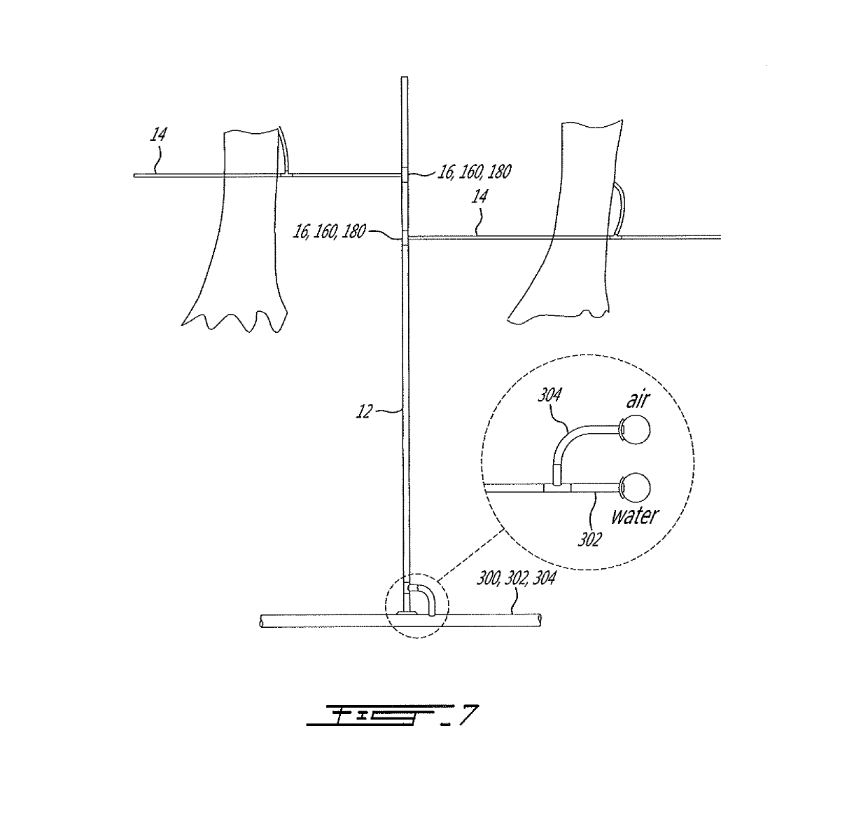

FIG. 1 shows a main line 12 (partly shown) connected to a draining line 14 (partly shown). FIG. 7 is a schematic view of a sap collecting system comprising a wet and dry line 300 connected between the main line 12 and a vacuum pump in the sugarhouse (not shown).

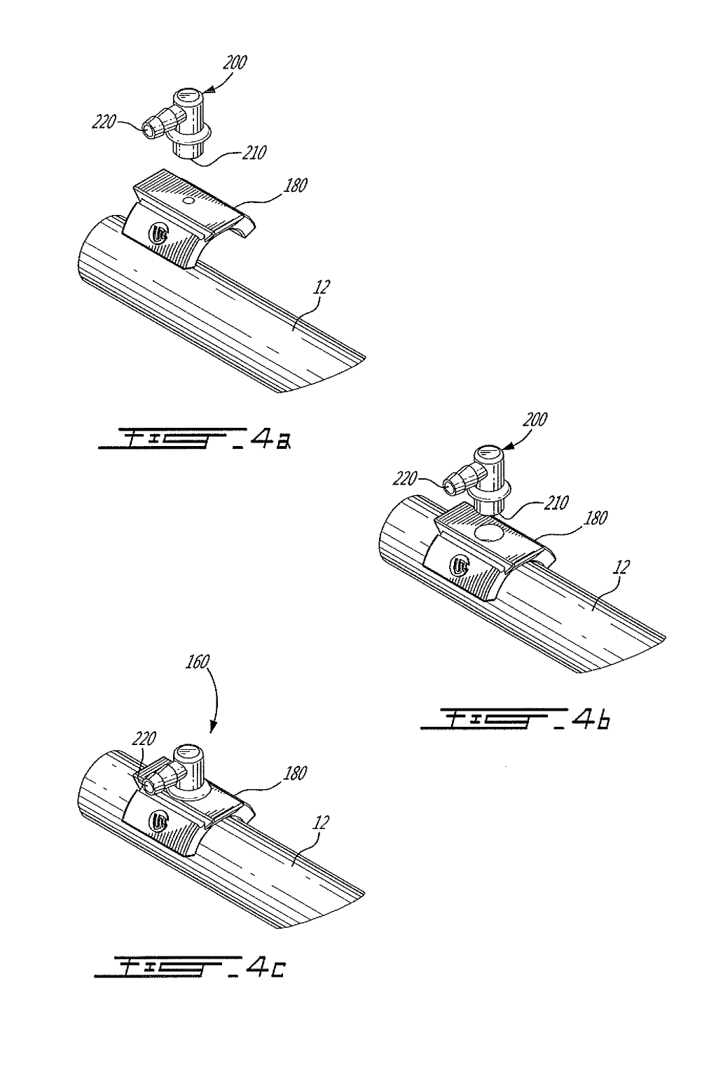

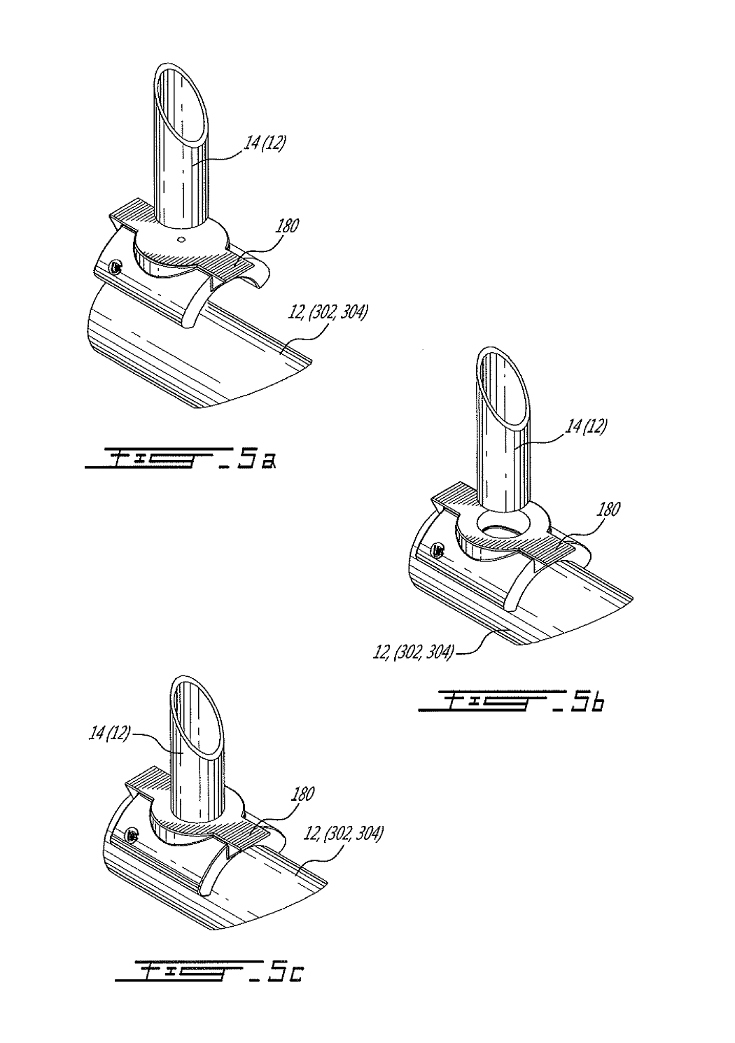

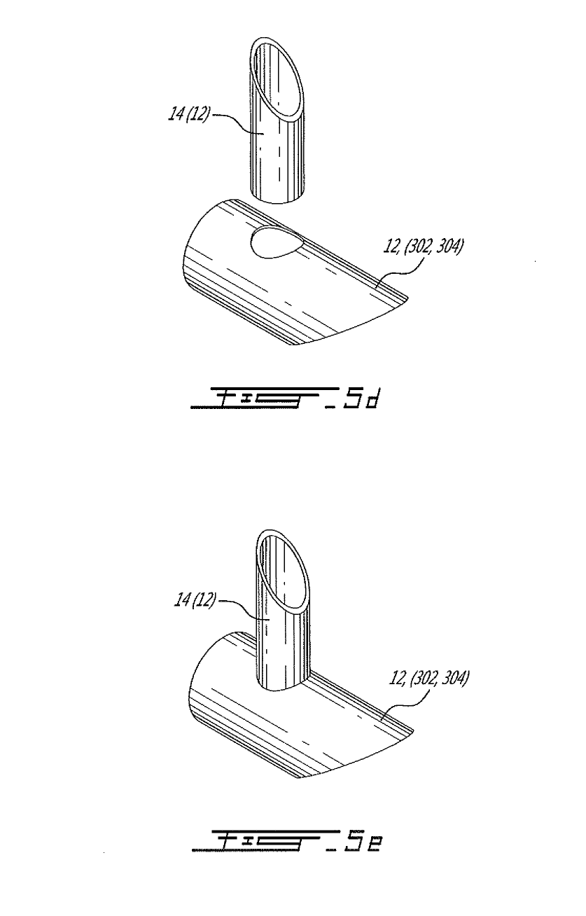

In an embodiment illustrated for example in FIGS. 2 and 3, a connector 16 integral with the main line 12 is used for connecting the main line 12 to a draining line 14 (FIG. 2). As best seen in FIG. 3, the connector 16 comprises a base 18 and a connecting part 20. The base 18 is a part cylinder, adapted to be positioned on and fused, by a lower surface thereof, with the wall of the main line 12 around an opening 24 in the wall of the main line 12 (see fusion surface 22 in FIG. 2a). The base 18 comprises an opening corresponding to the opening 24 of the main line 12, and a channel 26 extending from the opening in the base 18 through the connecting part 20, to an end fitting 15 of the connecting part 20. The opening of the base 18 may be provided with a positioning ring 13, around the circumference of the opening of the base 18, protruding from the lower surface of the base 18 fused with the wall of the main line 12 into the main line 12, to ease positioning of the connector 16 over the opening 24 of the main line 12 and alignment of the channel 26 with the opening 24.

Once the main line 12 with integral connectors 16 is suspended between trees, draining lines 14 may then be connected to the main line 12 by insertion of the end fitting 15 of the connecting part 20 of the connectors 16 in an open end of the draining lines 14, each draining line 14 thus in fluid communication with the main line 12 through the channel 26 of its respective connector 16.

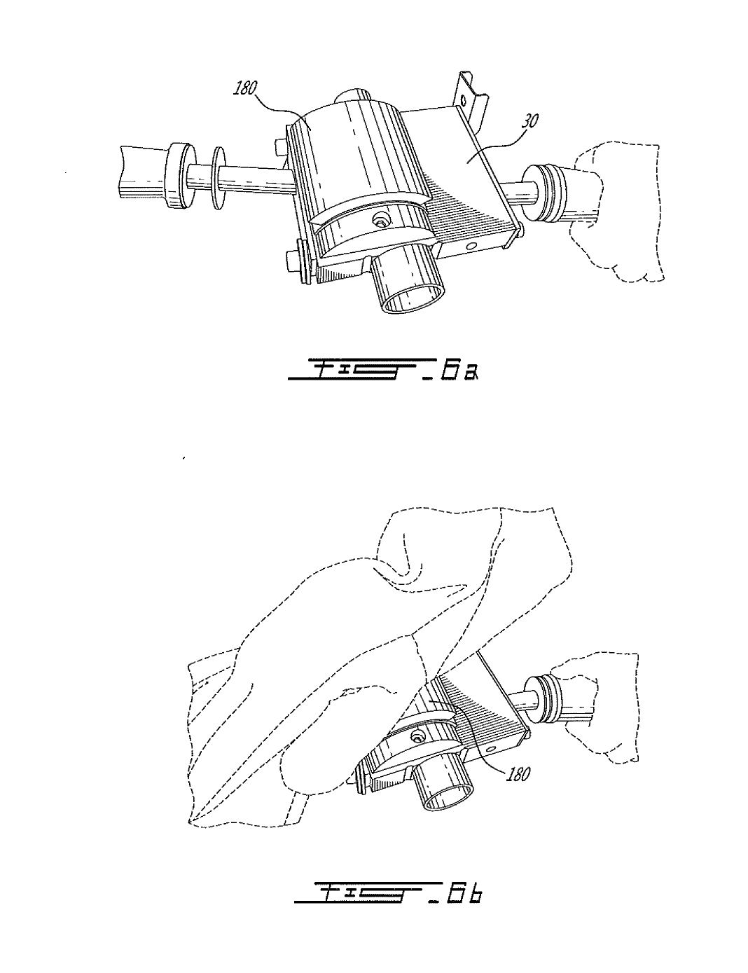

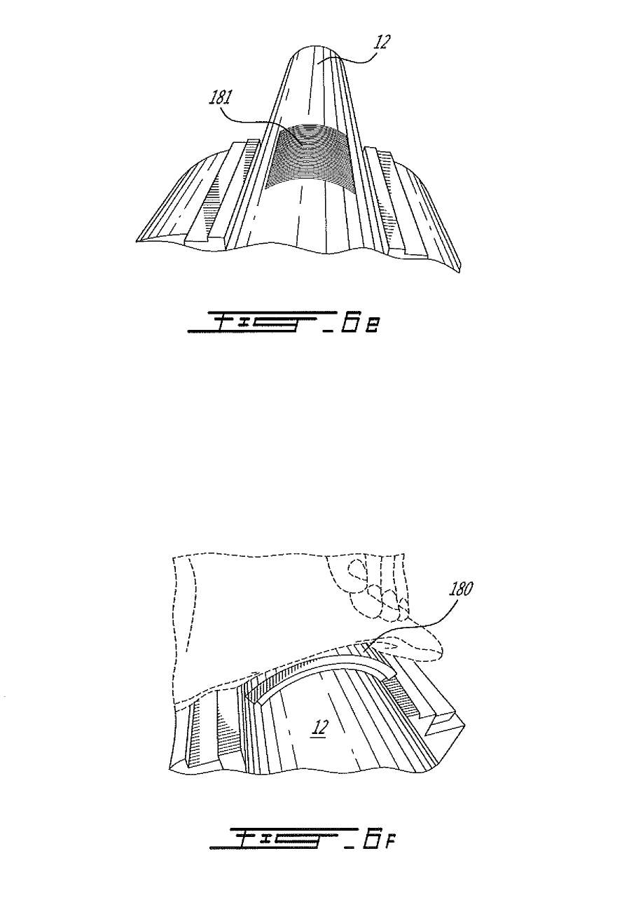

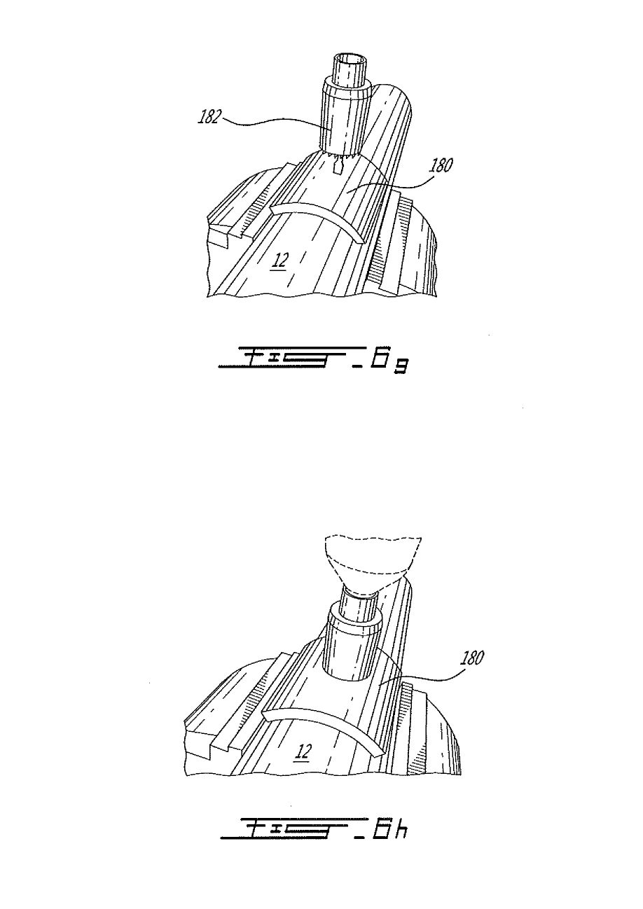

In another embodiment illustrated in FIG. 4 for example, the connector 160 comprises a base 180 and a connecting part 200. The base 180 has a saddle shape adapted to be positioned on and fused with the wall of the main line 12. The connecting part 200 comprises a first end fitting 210 and a second end fitting 220. The base 180 is fused with the wall of the main line 12, then the connecting part 200 is connected to the base 180 by fusing the first end fitting 210 in an opening drilled through both the base 180 and the fused wall of the main line 12, as will be described hereinbelow in relation to FIG. 6, thus providing a connector 160 integral with the main line 12 (see FIG. 4c). A draining line 14 may then be connected to the main line 12 by insertion of the end fitting 220 of connecting part 200 into the draining line 14.

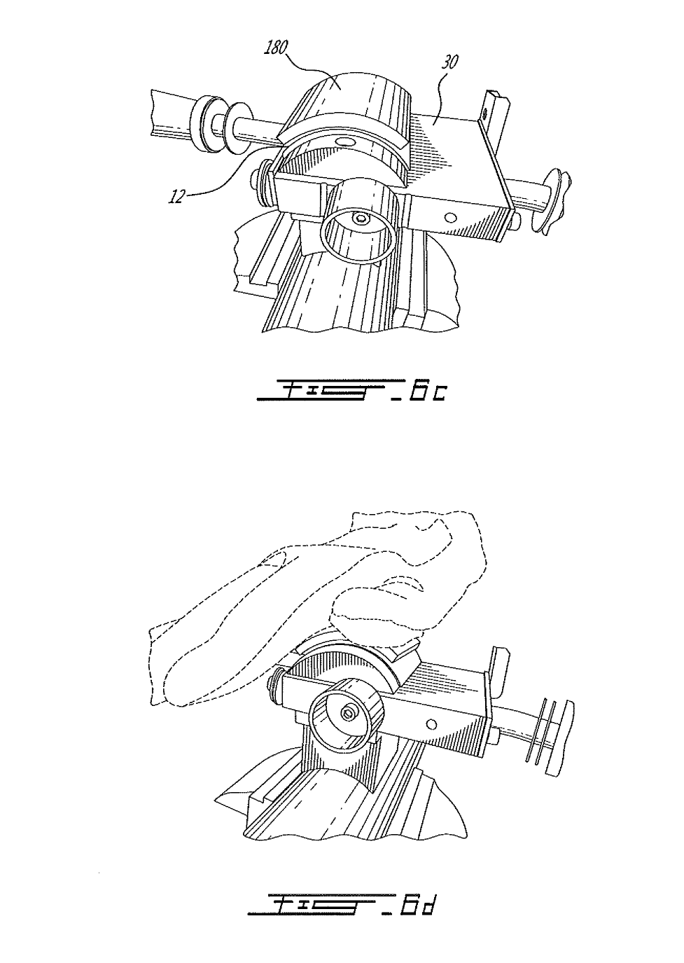

In another embodiment illustrated in FIGS. 5a) to 5c) for example, the connection comprises a base 180 fused with the wall of the main line 12, or of a wet 30 or dry line 312.

There is thus provided a main line with an integral connector, the connector and the main line forming one single piece thereby ensuring fluid-tightness. The base 18, 180 may cover between about 1/16 and ⅔ of the circumference of the main line 12 or of the wet or dry lines, for example between about of ⅛ and ½ of the circumference of the main line 12 or of the wet or dry lines. As a result, the present connector uses less material than a ring-like connector. The base is selected with a thickness in a range between about ½ and 10 times the thickness of the wall of the main line or of the or of the wet or dry lines for a strong connection. Typically, a main line has a wall with a thickness in a range between about 40 milli-inch and 200 milli-inch, for example of about 100 milli-inch. Typically, a wet line or a dry line has a wall with a thickness in a range between about 100 milli-inch and 600 milli-inch

In another embodiment illustrated in FIGS. 5d) and 5e) for example, the connection comprises the material of the walls in an opening of the wall of the main line 12, or of a wet 30 or dry line 312, fused with the material of an end of a draining line 14, or a main line 12.

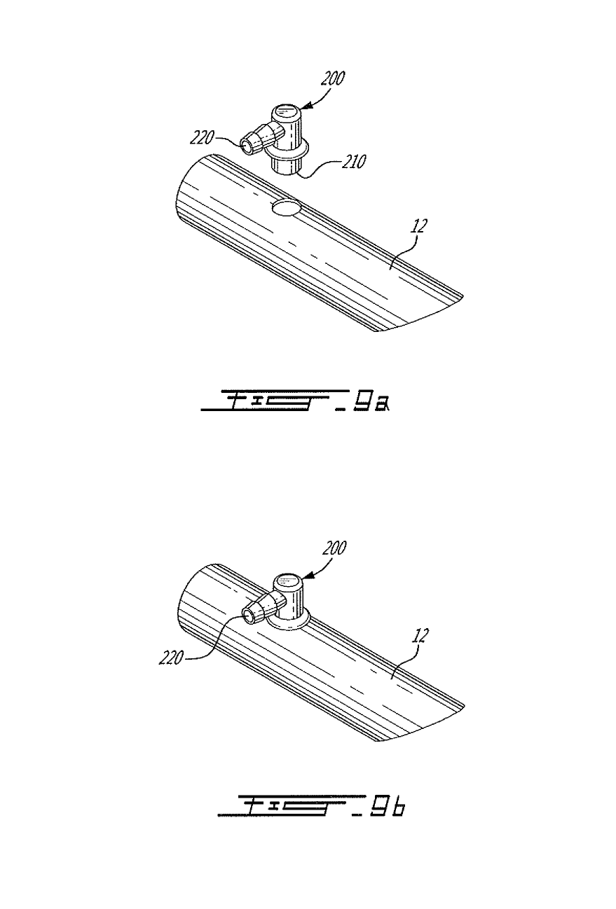

In another embodiment illustrated in FIG. 9 for example, the connection comprises a connecting part 200, made in a material that may be fused with the material of the main line 12, such as polyethylene for example, In such cases, the end fitting 210 is fused within an opening of the main line 12, and the end fitting 220 is available for connection with a draining line.

The main line and the connection are made of materials that may be fused together. Polyethylene, such as high, medium or low density PE for example, may be used.

It is found that such main line with integrated connectors may last at least 10 years in a sugar bush, free of leaking problems.

As people in the art will appreciate, the present invention thus provides connection between a main line and draining lines and/or wet and dry lines using only a limited number of different materials, i.e. materials that may be fused together, which allows recycling and is therefore environment friendly.

In a method according to an embodiment of the present invention, once the main line is hang in the sugar bush for example, an opening is drilled at a desired location in a wall of the main line; then the material of the walls of the opening of the main line is heated using a heating iron for example to heat and form a melting surface, and the material about an end of a draining line is heated using a heating iron for example to heat and also form a melting surface. The end of the draining line is then inserted within the opening in the main line and fused therewith, thereby connecting the draining line to the main line. In a similar method, the main line may be connected to a wet or dry line, by drilling an opening in the wet or dry line, heating the material of the walls of the opening of the wet or dry line and heating the material of a free end of the main line, then inserting the free end of the main line within the opening of the wet or dry line for fusion therewith.

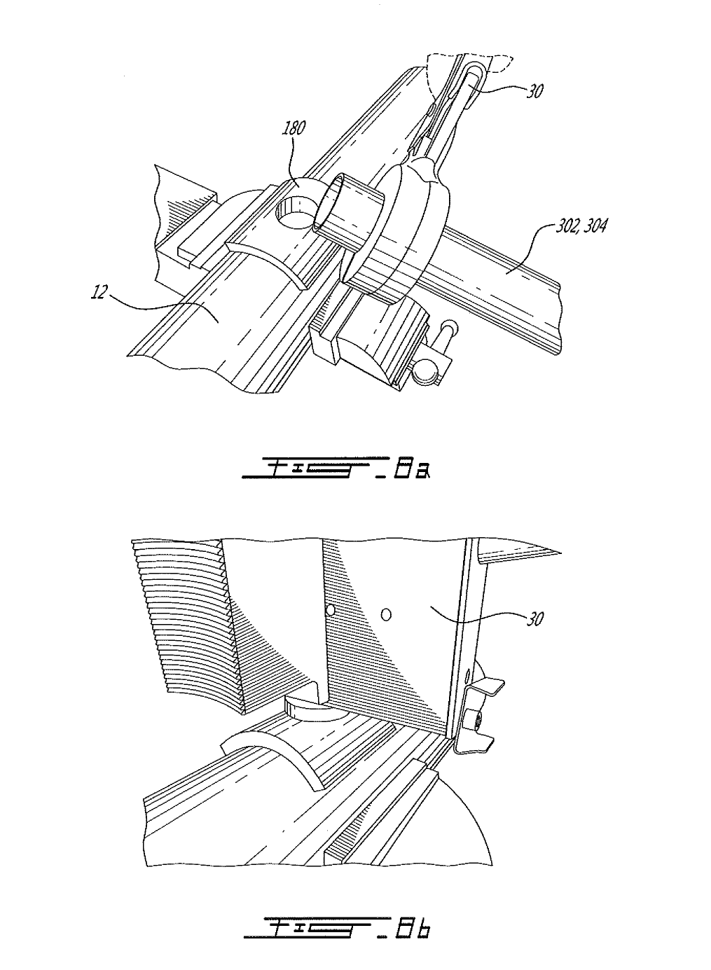

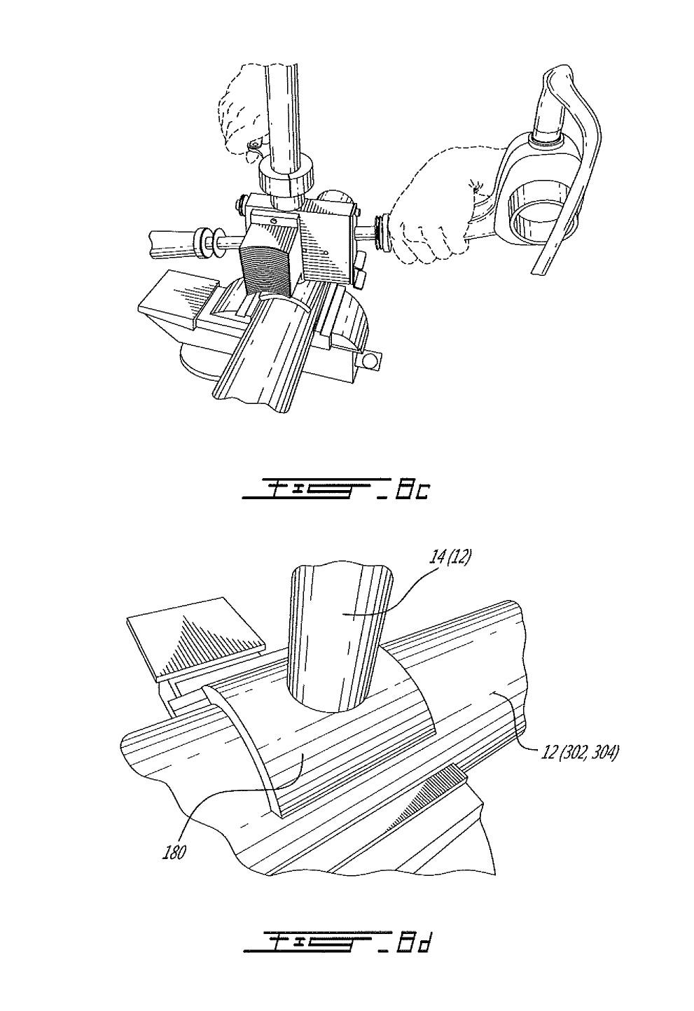

In a method according to another embodiment of the present invention, the base 180 of a connector 160 is deposited on a heating iron 30 preheated at about 525 F for example (see FIG. 6a), pressure is maintained for a few seconds between the base 180 and the heating iron 30 (see FIG. 6b), then the heating iron 30 with the base 180 on a surface thereof is positioned over the main line 12 and a pressure is applied with a hand for a few seconds (see FIG. 6d). The heating iron 30 is then removed, the base 180 deposited on the melted surface 181 (see FIG. 6e) of the main line 12 and maintained there under pressure for about 1 minute (see FIG. 6f). An opening is then drilled at the center of the base 180 through both the base 180 and the fused wall of the main line 12 using a hole saw 182 for example (see FIGS. 6g and 6h). The material of the walls of the opening through both the base 180 and the fused wall of the main line 12 is then heated using the heating iron to heat and form a melting surface (see FIG. 8b), and the material about an end of a draining line is heated using the heating iron for example to heat and also form a melting surface (see FIG. 8c). The end of the draining line is then inserted within the opening and fused therewith, thereby connecting the draining line to the main line (see FIG. 8d). In a similar way, the main line may be connected to a wet or dry line, by fusing a base 180 on the wet or dry line, then drilling an opening through both the base 180 and the fused wall of the wet or dry line, heating material of the walls of the opening through both the base 180 and the fused wall of the wet or dry line and a free end of the main line, then inserting the free end of the main line within the opening through both the base 180 and the fused wall of the wet or dry line for fusion therewith.

In a method according to another embodiment of the present invention, once the main line is hang in the sugar bush for example, an opening is drilled at a desired location in a wall of the main line; then the material of the main line and the material of the base 18 of a connector 16 are heated using a heating iron for example to heat and form a melting surface on the main line about the opening and on the lower surface of the base 18, and the connector 16 is fused to the main line by its base 18, about the opening in the main line 12. In a matter of seconds, a bond is achieved between the base 18 and the main line about the opening of the main line 12, and the main line and the connector form one single piece, available for connection to a draining line by the connecting part of the connector 16.

In a method according to another embodiment of the present invention, the base 180 of a connector 160 is deposited on a heating iron 30 preheated at about 525 F for example (see FIG. 6a), pressure is maintained for a few seconds between the base 180 and the heating iron 30 (see FIG. 6b), then the heating iron 30 with the base 180 on a surface thereof is positioned over the main line 12 and a pressure is applied with a hand for a few seconds (see FIG. 6d). The heating iron 30 is then removed, the base 180 deposited on the melted surface 181 of the main line 12 and maintained there under pressure for about 1 minute (see FIG. 6e). An opening is then made at the center of the base 180 through the fused wall of the main line 12 using a hole saw 182 (see FIG. 6f). Then the end fitting 210 of the connecting part 200 of the connector 160 is fused within the opening on the base 180, thereby forming a main line with an integrated connector. The draining line 14 may then be connected to the main line 12 through the end fitting 220 of the connecting part 200 of the connector 160, to be in fluid communication with the main line 12.

The heating iron may be powered by a generator mounted on a vehicle for example, or battery or gas powered for example.

A sugar maker may thus install a pipeline by running a main line straight up a hill, and laying out smaller draining lines on both sides, the main line being connected, in fluid communication, with a plurality of draining lines at connectors 16, 160 or 180.

The main line, of a diameter between about ½ inch and about 2 inch for example, is in fluid communication with each of the respective draining lines, the draining lines having a diameter between about ¼ inch and about ¾ inch for example.

A wet and dry line 300 may be connected between the main line 12 and a vacuum pump in the sugarhouse (not shown), as illustrated in FIG. 7. The wet and dry line 300 comprises a wet line 302 directing sap from main lines to the sugarhouse and a dry line 304 for air. It is found that the dry line allows a uniform distribution of vacuum among the main lines of a collecting system, especially in case of large sap collecting systems. Depending on the extent of the collecting system, i.e. on the number of main lines connecting to the wet and dry line 300, the diameter of each one of the wet line 302 and the dry line 304 may vary between about 1 inch and about 4 inch for example.

A main line 12 may be connected to each one of the lines 302 and 304 using a base 180 as described above. A base 180 is fused on the line 302 or 304, then an opening is drilled. Then a free end of the main line is heated and the walls of the opening in line 302 or 304 is also heated (see FIG. 8a-8c) so as to melt the respective materials. Then the end of the main line is inserted within the opening and held there for fusion of the materials thereof with the material of the line 302 or 304, thereby connecting the main line 12 to the line 302 or 304 (see FIG. 8d). Alternatively, as described hereinabove, the main line 12 may be fused in an opening drilled in the line 302 or 304 without first fusing a base 180 on the line 302 or 304.

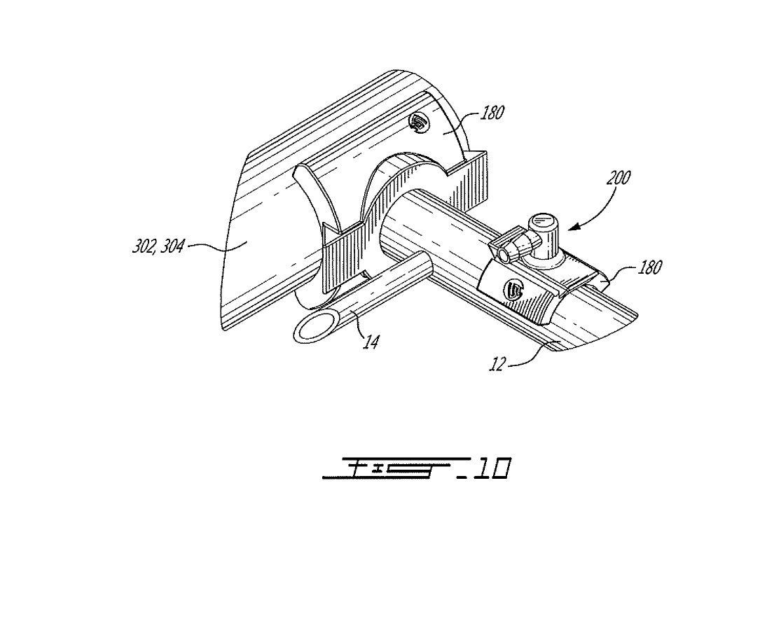

As shown for example in FIG. 10, the connections of the present invention may be combined in sap collection system.

The scope of the claims should not be limited by the embodiments set forth in the examples, but should be given the broadest interpretation consistent with the description as a whole.

What is claimed is:

1. A sap collection system, comprising:
at least a first line of a first diameter;
at least a second line of a second diameter, said second diameter being at most equal to said first diameter; and
a connection in fluid communication between said second line and said first line for sap collection from said first line to said second line;
wherein said connection comprises a material of walls of an opening in a wall of said first line fused with a material of one of: i) an end of said second line and ii) a connecting part engaging an end of said second line.

2. The sap collection system of claim 1, wherein said connection further comprises a base, said base being fused on said first line in fluid communication with said first line through said opening, said connection comprising the material of the end of said second line fused with the material of the walls of the opening in the wall of said first line and the material of said base about said opening.

3. The sap collection system of claim 1, wherein said connection further comprises a base, said base being fused on said first line in fluid communication with said first line through said opening, said connection comprising the material of the end of said second line fused with the material of the walls of the opening in the wall of said first line and the material of said base about said opening, said base covering between about 1/16 and ⅔ of the circumference of the first line.

4. The sap collection system of claim 1, wherein the end of said second line is engaged in a first end fitting of a connecting part, said connecting part comprising a second end fitting in fluid communication with said first end fitting, said connection comprising the material of said second end fitting fused with the material of the walls of the opening in the wall of said first line.

5. The sap collection system of claim 1, wherein said connection further comprises a base, said base being fused on said first line in fluid communication with said first line through said opening, and the end of said second line is engaged in a first end fitting of a connecting part, said connection comprising the material of said second end fitting fused with the material of the walls of the opening in the wall of said first line and the material of said base about said opening.

6. The sap collection system of claim 1, wherein said connection further comprises a base, said base being fused on said first line in fluid communication with said first line through said opening, and the end of said second line is engaged in a first end fitting of a connecting part, said connection comprising the material of said second end fitting fused with the material of the walls of the opening in the wall of said first line and the material of said base about said opening, said base covering between about 1/16 and ⅔ of the circumference of said first line.

7. The sap collection system of claim 1, wherein said connection comprises the material of the walls of the opening in the wall of said first line fused with the material of the end of said second line.

8. The sap collection system of claim 1, wherein said first line is one of: i) a main line, ii) a wet line and iii) a dry line and said second line is one of: i) a main line and ii) a draining line.

9. The sap collection system of claim 1, wherein said materials comprise polyethylene.

10. A system for sap collection, comprising:
a first line with an integral collector; and
at least a second line;
wherein said integral collector is in fluid communication with said first line and adapted for connection in fluid communication with said second line for sap collection from said first line to said second line.

11. The system of claim 10, wherein said collector comprises a base fused in fluid communication with said first line.

12. The system of claim 10, wherein said collector comprises a connecting part fused in fluid communication with said first line, said connecting part comprising an end fitting adapted for connection with the second line.

13. The system of claim 10, wherein said collector comprises a base fused in fluid communication with said first line and a connecting part in fluid communication with said base, connecting part comprising an end fitting adapted for connection with the second line.

14. The system of claim 10, wherein said first line with an integral collector is made in polyethylene.

15. The system of claim 10, wherein said first line has a diameter between about ½ inch and about 2 inch and said second line has a diameter between about ¼ inch and about ¾ inch.

16. The system of claim 10, wherein said first line has a diameter between about 1 inch and about 4 inch and said second line has a diameter between about ½ inch and about 2 inch.

17. A method for installing a sap collecting system in a bush, comprising:
providing at least a first line;
providing at least a second line; and
fusing the material of walls of an opening in a wall of said first line with a material of one of: i) an end of the second line and ii) a connecting part engaging an end of the second line, into a connection in fluid communication between the second line and the first line for sap collection from the first line to the second line.

18. The method of claim 17, wherein said providing a first line comprises providing a a base and fusing the base on the first line in fluid communication with the first line through the opening;
and said fusing comprises fusing the material of the end of the second line with the material of the walls of the opening in the wall of the first line and the material of the base about said opening.

19. The method of claim 17, wherein said providing a second line comprises providing a connecting part comprising a first end fitting and a second end fitting, the second end fitting being in fluid communication with the first end fitting, and engaging the first end fitting in the end of the second line; and said fusing comprises fusing the material of the second end fitting with the material of the walls of the opening in the wall of the first line.

20. The method of claim 17, wherein said providing a first line comprises fusing a base on the wall of the first line in fluid communication with the first line; said providing a second line comprises providing a connecting part comprising a first end fitting and a second end fitting, the second end fitting being in fluid communication with the first end fitting, and engaging the first end fitting in the end of the second line; and said fusing comprises fusing the material of the second end fitting with the material of the walls of the opening in the wall of the first line and the material of the base about the opening.

21. The method of claim 17, wherein said providing a first line comprises providing a main line; and said providing a second line comprises providing a draining line.

22. The method of claim 17, wherein said providing a first line comprises providing one of: i) a wet line and ii) a dry line, and said providing a second line comprises providing a main line.
